(19) United States
(12) Patent Application Publication
(10) Pub. No.: US 2012/0102361 A1
(43) Pub. Date: Apr. 26, 2012

(54) HEURISTIC POLICY ANALYSIS

(75) Inventors: Rami Sass, Tel-Aviv (IL); Ehud Amiri, Newton, MA (US)

(73) Assignee: COMPUTER ASSOCIATES THINK, INC., Islandia, NY (US)

(21) Appl. No.: 12/911,288

(22) Filed: Oct. 25, 2010

(51) Int. Cl. G06F 11/28

(52) U.S. Cl. 714/37; 714/E11.178

(57) ABSTRACT

A system and method using statistical analysis for the process of analyzing and generating organizational policies is presented. This inventive method comprises, for one or more tests, using a test to calculate a test result for the policy based on current violator entities and potential violator entities, and determining a policy ranking for the policy based on the test result of the test, and evaluating the policy based on the policy rankings determined from the tests. The method can also comprise creating a repository comprising the policy rankings for the plurality of policies. The repository can be used to trend, benchmark, alert and improve the policies. The method can also comprise creating a rule profile for the one policy comprising the one policy, the current violator entities of the policy, the potential violator entities of the policy, the test results and the policy rankings from the tests.

### FIELD

The present disclosure relates generally to computer systems and software, and more particularly to creating, maintaining and evaluating policies.

### BACKGROUND

Organizations, particularly large organizations, have policies generated by multiple sources for a variety of different purposes. Some of these policies may include adherence to federal, state and local laws and regulations. Other policies may enforce internal organizational guidelines and so on. An example of a policy can be that an employee cannot submit an expense report and approve the same report. Another example can be that only internal employees can have access to sensitive corporate information.

Over time, as the organization changes, additional policies may be added, mergers, acquisitions and/or other organizational structural changes may occur, and/or external regulations may change, so that the overall effectiveness of policies are often degraded. Consequentially, policies may become irrelevant or of poor quality. Further, policy maintenance is done manually and is error prone. In a large organization, internal and external regulations may result in hundreds or even thousands of policy rules. Even when these are enforced automatically by different systems, the policy rules still degrade over time and are not optimized.

Currently, no coherent method exists that measures policies' usefulness, such as by quantifying and evaluating policies. This means that monitoring, cleaning and maintaining organizational policies are complicated tasks. There is a need for a consistent way to measure the value of policies and policy rules.

### BRIEF SUMMARY OF THE INVENTION

A method and system using statistical analysis for the process of analyzing and generating organizational policies is presented. The method measures policy usefulness and effectiveness, and computes policy quality. The method includes initial generation of a policy model as well as ongoing policy maintenance and optimization as the organization evolves. The method also offers decision support mechanisms for creating and reviewing policies. The method is made up of several types of analysis to qualify and profile policies and policy rules. Additional analysis capabilities are utilized to assist in the creation or generation of new policies.

A mechanism to analyze policy rules based on various statistical criteria is presented. This inventive method comprises, for one or more tests, using a test to calculate a test result for one policy based on current violator entities of the policy and potential violator entities of the policy, the calculating being performed using a processor, and determining a policy ranking for the policy based on the test result of the test, and evaluating the policy based on the policy rankings determined from the one or more tests. In one aspect, the method can also comprise employing processes to trend, benchmark, alert and improve one or more of the plurality of policies, said employing performed using at least one of the policy rankings, the current violator entities, the potential violator entities, and the test results. In one aspect, the method can also comprise creating a repository comprising the policy rankings for the plurality of policies and obtaining a list of suspicious rules from the repository. In one aspect, method can also comprise creating a rule profile for the policy comprising the policy, the current violator entities of the policy, the potential violator entities of the policy, the test results and the policy rankings from the one or more tests.

A system for auditing one policy of a plurality of policies in an organization having a plurality of entities is also presented. This inventive system comprises a processor on a server, a database on the server, and a module operable to perform, for one or more tests, calculations using a test to calculate a test result for one policy based on current violator entities of the policy and potential violator entities of the policy, the calculating being performed using the processor, and determining a policy ranking for the policy based on the test result of the test, and evaluating the policy based on the policy rankings determined from the one or more tests. In one aspect, the module is also operable to employ processes to trend, benchmark, alert and improve one or more of the plurality of policies, said employing performed using at least one of the policy rankings, the current violator entities, the potential violator entities, and the test results. In one aspect, the module is also operable to create a repository comprising the policy rankings for the plurality of policies. In one aspect, the module is also operable to create a rule profile for the policy comprising the policy, the current violator entities of the policy, the potential violator entities of the policy, the test results and the policy rankings from the one or more tests.

A computer readable storage medium and/or device storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a schematic diagram illustrating components for a system in accordance with one embodiment of the present invention.

FIG. 2 is a diagram of a sample policy with components.

FIG. 3 is a diagram illustrating identifying redundant policies.

FIG. 4 is a flow diagram illustrating an embodiment of the present invention.

### DETAILED DESCRIPTION

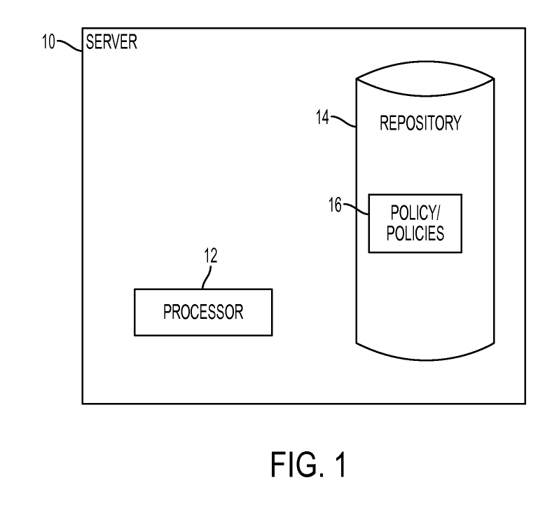

An inventive system and method for creating and maintaining policies is presented. The novel system and method measures policy usefulness and employs processes using these measurements to trend, benchmark, alert and improve the policies. As shown in FIG. 1, in one embodiment, the inventive system comprises a server 10 housing a CPU or processor 12 and a repository or database 14. The database 14 can contain one or more policies 16. A policy 16 has an operative item known as a rule, which can be applicable to an organizational entity. Organizational entities can be, for example in role management products, users, roles and resources. The inventive system and method measures and/or determines the quality of the rules.

In one aspect, the characteristics or metrics of a rule are: type, current entities that are violators (current violators), and potential entities that could be violators (potential violators).

The type characteristic of a rule should be as granular as possible without referring to concrete entities. For example, one type could be “role-role, forbidden”. In this type, members of roles {x} are forbidden to be members of roles {y}. Another type of rule could be “role-role, must have reason”, in which the members of role {x} must also be members of role {y}.

The current violators (“V”) characteristic of a rule can include entities which are currently causing a violation to the rule.

The potential violators (“P”) characteristic of a rule can include the set of entities the rule is designed to protect. These are entities that the rule is applicable to and that can, potentially, be in violation of this rule. None of these entities are presently in violation or conflict with the rule.

For example, suppose an organization has a policy to prevent co-mingling of certain types of information. This organization can have a rule that members of the finance department cannot have access to the UNIX computer. The type of rule would be “role-role, forbidden”. The current violators V would be anyone in the finance department who has access to the UNIX computer, e.g., anyone who works in the finance department and has a valid log-on identifier for the UNIX computer. The potential violators P would be everyone in the finance department and everyone who has access to the UNIX computer.

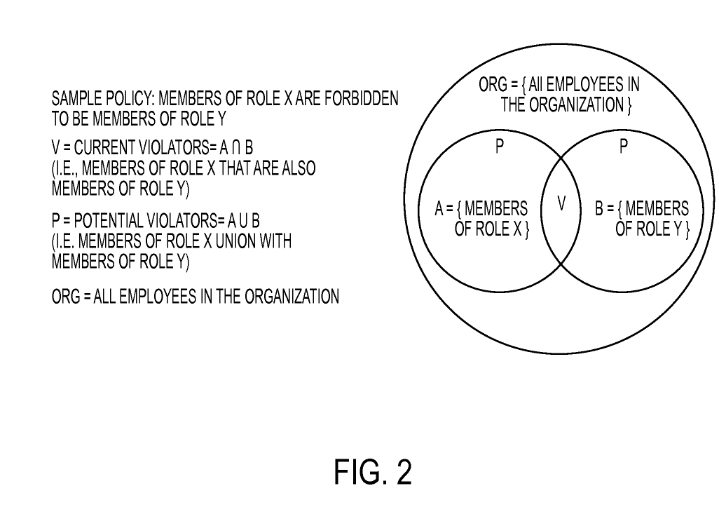

FIG. 2 is a diagram of a sample policy for segregation of duties. In this sample policy, members of an organization are segregated based on their duties. In FIG. 2, members of role X are forbidden to be members of role Y. For example, if members of role X are external employees, such as contractors, and members of role Y are employees who view sensitive corporate information, the external employees cannot view the sensitive corporate information. As shown in FIG. 2, A=members of role X, B=members of role Y, and Org=all employees (including contractors) in the organization. The current violators V are shown as the intersection of members of role X with members of role Y, that is, members of role X who are also members of role Y, e.g., A∩B. The potential violators P are shown as the union of the members of role A with the members of role B, that is, the members of role X or the members of role Y, e.g., A4B.

The novel system and method uses multiple tests, or statistical tools, to compute or obtain multiple scores for each policy to reflect the multiple dimensions of the policy's effectiveness. The statistical analysis enables visualizing the policy effectiveness compared to other policies, trending policy effectiveness over time, identifying policies that are degrading and suggesting possible correction paths to improve policy effectiveness.

Exemplary tests to apply to a rule in order to estimate its quality, or qualify the rule, are now presented. Each of these tests can be assigned a score in the range of 0-100 in a pretty straightforward way, as known to those skilled in the art. These tests are presented for illustration purposes only and are not meant to be a complete list.

In one test, set some minimum and/or maximum values to V and/or P. A rule whose characteristics deviate from the defined range of either V or P will be considered suspicious. Accordingly, rules which have a very large potential population, e.g., large number of entities which are potential violators P, and/or cover almost the entire organization might be too general or indicate some design flaw in the security methodology, and thus can be considered suspicious. Using similar logic, rules which have a very small potential population are probably not very effective or significant and thus can also be ranked as suspicious.

Another test can check type based cohesion. In this test, for each type characteristic of the rule, calculate the averages of V and P as well as their standard deviations (STDs). Rules which deviate more than a given number of STDs from the average can be considered suspicious. For example, rules that deviate more than two STDs can be ranked as suspicious.

Yet another test can check population based patterns. For a given rule, check rules with similar populations or entities, particularly those with similar potential violators P. Similar rules can include, for example, rules within one organizational unit, or all “role-role, forbidden” rules. If the rule deviates in V or P from similar rules, it can be considered suspicious. For example, if a given rule has P much larger or smaller than the P of another, similar rule, the given rule can be ranked as suspicious.

Still another test can check population trends. In this test, changes to V and P over time are checked. Hence, when performing periodic sampling of the policies' test results, one could trend the results and figure out the trajectory of the progress and perform extrapolation as to when a remediation action will be needed. For example, if a rule reaches P of a given percent of its original P, the rule is suspicious. In addition, or in the alternative, if V or P for a rule shifts more than a certain percent over a given amount of time, the rule is ranked as suspicious. Advantageously, the percentages and amounts of time can be parameterized.

Another test can be performed to measure the V/P ratio. Rules which have unusually low or high V/P measurements will also be considered suspicious.

These tests, and similar ones, performed individually enable the creation of a repository, e.g., a database, of policy information, including rules, current and potential violators and suspicions about the rules, e.g., policy rankings. This repository can include a list of rule suspicions, a rule profile which details the state of the rule, and/or an aggregation of all of the test scores to a single score which is assigned to the rule. Additional information can also be included in the repository.

The repository or database of policy information enables comparison between policies, between parts of the organization and between organizations. These comparisons or benchmark tests can yield useful information about the policies.

Another relevant metric for use in policy quality determination relates to the entities. Entities which frequently and/or regularly appear as current violators will probably already have visibility, since this is what the rules were originally designed to do. However, entities which appear in the potential population, e.g., potential violator entities, of many rules can be considered in accordance with the inventive system and method. These potential violators of many rules can be regarded as “high interest” entities and special tests can be tailored for them. The tests and their results can be used to refine the above metrics. In some situations, rules with very small P but that have entities with their population that are “high interest” will be less suspicious. For example, there can be a policy that is very focused, that is a policy having a small P where P includes very sensitive people, such as the CEO, CFO, etc., or very sensitive resources, such as merger and acquisition documents. These P's are often defined as “high interest” entities and while there can be many policies for them, they are typically not suspicious.

Policy rules of the same or similar types, that is, rules having the same or similar type characteristics, that have a large common potential population should be identified. Such rules should be considered for merger or elimination of some of them. Such situations may indicate that the same business rule might have entered the system more than once, possibly by different policy authors or at different times.

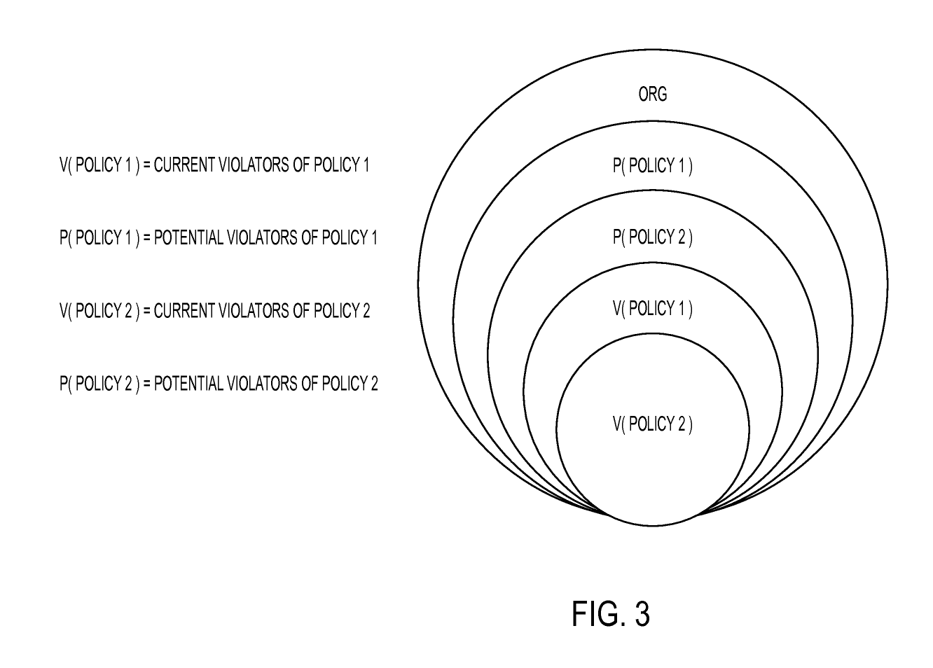

FIG. 3 shows identifying redundant policies. In FIG. 3, Org=members of the organization, V(Policy1) are current violators of policy 1, P(Policy1) are potential violators of policy 1, V(Policy2) are current violators of policy 2, and P(Policy2) are potential violators of policy 2. As can be seen from FIG. 3, all of the current violators of policy 2 are also current violators of policy 1 and all of the potential violators of policy 2 are potential violators of policy 1. Thus policy 2 is suspicious as it could be a redundant policy.

Additionally, entity pattern checks can be leveraged to instigate the generation of new policy rules. Pattern recognition algorithms can be used to find clusters of similar policies, that is, policies with very similar but not identical P and V, and entities or relationships can be classified as either within the cluster or “out-of-pattern”. After identifying the entities or relationships that are out-of-pattern, rules can be suggested to prevent these deviations from happening in the future. Out-of-pattern test results can be crossed with the identification of “high interest” entities, as discussed above, to suggest more meaningful policies. For example, out-of-pattern tests can be done by role management products to identify suspicious, e.g., out-of-pattern, roles or privileges.

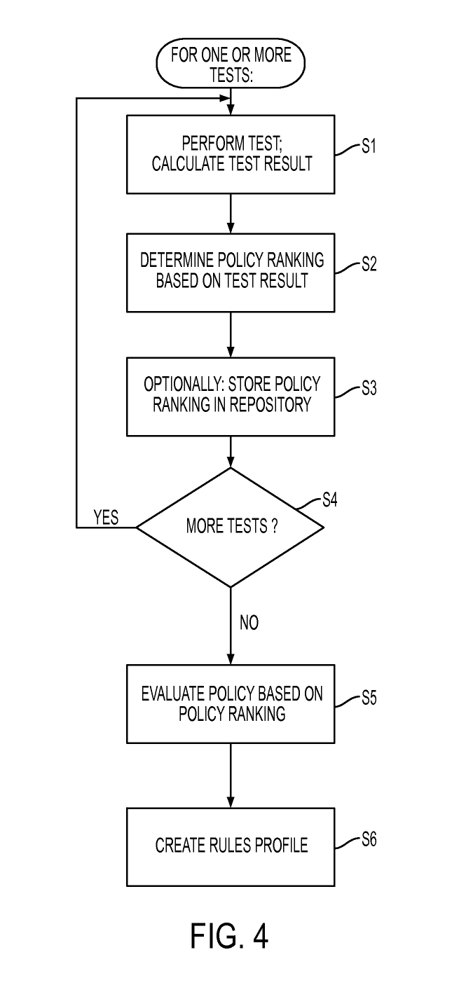

FIG. 4 is a flow diagram of the inventive method. Calculations are performed in accordance with one or more tests, such as the tests described above. In step S1, a particular test is performed and a test result is calculated. In step S2, policy ranking is determined based on the test result. In one embodiment, the policy ranking is stored in a repository in Step S3. If there are more tests (S4=YES), then steps S1 and S2, and optionally step S3, are performed with another test, so that another test result is calculated and another policy ranking is determined, and optionally stored.

Steps S1 and S2, and optionally step S3, are repeated until there are no more tests to perform. When this occurs (S4=NO), the policy is evaluated based on the policy ranking(s) in step S5. In one embodiment, in step S6, a rules profile is created.

The novel approach presented above enables automation of policy management. Automation of policy review can significantly improve policy quality and prevent internal conflicts or inefficiencies.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for measuring usefulness of one policy of a plurality of policies in an organization having a plurality of entities, comprising steps of:
for one or more tests:
using a test to calculate a test result for the one policy based on current violator entities of the one policy and potential violator entities of the one policy, said calculating being performed using a processor; and
determining a policy ranking for the one policy based on the test result of the test; and
evaluating the one policy based on the policy rankings determined from the one or more tests.

2. The method of claim 1, further comprising the step of employing processes to trend, benchmark, alert and improve one or more of the plurality of policies, said employing performed using at least one of the policy rankings, the current violator entities, the potential violator entities, and the test results.

3. The method of claim 1, further comprising:
creating a repository comprising the policy rankings for the plurality of policies; and
obtaining a list of suspicious rules from the repository.

4. The method of claim 1, further comprising a step of creating a rule profile for the one policy comprising the one policy, the current violator entities of the one policy, the potential violator entities of the one policy, the test results and the policy rankings from the one or more tests.

5. The method of claim 1, wherein one test of the one or more tests comprises steps of:
establishing a current violator entities range and a potential violator entities range; and
setting the policy ranking based on whether the current violator entities of the one policy is within the current violator entities range and whether the potential violator entities of the one policy is within the potential violators entities range.

6. The method of claim 1, wherein one test of the one or more tests comprises steps of:
establishing a current violator entities mean, a current violators standard deviation, a potential violator entities mean and a potential violator entities standard deviation; and
setting the policy ranking based on whether the current violator entities of the one policy is within a value of the current violator entities standard deviation and whether the potential violator entities of the one policy is within a value of the potential violators entities standard deviation.

7. The method of claim 1, wherein one test of the one or more tests comprises steps of
establishing a current violator entities range and a potential violator entities range; and
setting the policy ranking based on whether the current violator entities of the one policy is within the current violator entities range and whether the potential violator entities of the one policy is within the potential violators entities range.

8. A computer readable storage medium storing a program of instructions executable by a machine to perform a method of evaluating usefulness of a policy, comprising:
for one or more tests:
using a test to calculate a test result for the one policy based on current violator entities of the one policy and potential violator entities of the one policy, said calculating being performed using a processor; and
determining a policy ranking for the one policy based on the test result of the test; and
evaluating the one policy based on the policy rankings determined from the one or more tests.

9. The computer readable storage medium of claim 8, further comprising employing processes to trend, benchmark, alert and improve one or more of the plurality of policies, said employing performed using at least one of the policy rankings, the current violator entities, the potential violator entities, and the test results.

10. The computer readable storage medium of claim 8, further comprising:
creating a repository comprising the policy rankings for the plurality of policies; and
obtaining a list of suspicious rules from the repository.

11. The computer readable storage medium of claim 8, further comprising creating a rule profile for the one policy comprising the one policy, the current violator entities of the one policy, the potential violator entities of the one policy, the test results and the policy rankings from the one or more tests.

12. The computer readable storage medium of claim 8, wherein one test of the one or more tests comprises:
establishing a current violator entities range and a potential violator entities range; and
setting the policy ranking based on whether the current violator entities of the one policy is within the current violator entities range and whether the potential violator entities of the one policy is within the potential violators entities range.

13. The computer readable storage medium of claim 8, wherein one test of the one or more tests comprises:
establishing a current violator entities mean, a current violators standard deviation, a potential violator entities mean and a potential violator entities standard deviation; and
setting the policy ranking based on whether the current violator entities of the one policy is within a value of the current violator entities standard deviation and whether the potential violator entities of the one policy is within a value of the potential violators entities standard deviation.

14. The computer readable storage medium of claim 8, wherein one test of the one or more tests comprises:
establishing a current violator entities range and a potential violator entities range; and
setting the policy ranking based on whether the current violator entities of the one policy is within the current violator entities range and whether the potential violator entities of the one policy is within the potential violators entities range.

15. A system for evaluating usefulness of a policy, comprising:
a processor on a server;
a database on the server;
a module operable to, for one or more tests, use a test to calculate a test result for the one policy based on current violator entities of the one policy and potential violator entities of the one policy, said calculating being performed using the processor, and determine a policy ranking for the one policy based on the test result of the test, and said module further operable to evaluate the one policy based on the policy rankings determined from the one or more tests.

16. The system of claim 15, wherein the module is further operable to employ processes to trend, benchmark, alert and improve one or more of the plurality of policies, said employing performed using at least one of the policy rankings, the current violator entities, the potential violator entities, and the test results.

17. The system of claim 15, wherein the module is further operable to create a repository comprising the policy rankings for the plurality of policies.

18. The system of claim 15, wherein the module is further operable to create a rule profile for the one policy comprising the one policy, the current violator entities of the one policy, the potential violator entities of the one policy, the test results and the policy rankings from the one or more tests.

19. The system of claim 15, wherein one test of the one or more tests is performed by:
establishing a current violator entities range and a potential violator entities range; and
setting the policy ranking based on whether the current violator entities of the one policy is within the current violator entities range and whether the potential violator entities of the one policy is within the potential violators entities range.

20. The system of claim 15, wherein one test of the one or more tests is performed by:
establishing a current violator entities mean, a current violators standard deviation, a potential violator entities mean and a potential violator entities standard deviation; and
setting the policy ranking based on whether the current violator entities of the one policy is within a value of the current violator entities standard deviation and whether the potential violator entities of the one policy is within a value of the potential violators entities standard deviation.

21. The system of claim 15, wherein one test of the one or more tests is performed by:
establishing a current violator entities range and a potential violator entities range; and
setting the policy ranking based on whether the current violator entities of the one policy is within the current violator entities range and whether the potential violator entities of the one policy is within the potential violators entities range.
